(19) United States
(12) Patent Application Publication
(10) Pub. No.: US 2025/0061487 A1
(43) Pub. Date: Feb. 20, 2025

(54) SYSTEMS AND METHODS FOR GENERATING, PROVIDING, AND MANAGING AUTOMATIC NOTIFICATIONS BASED ON USER PREFERENCES

(71) Applicant: Wells Fargo Bank, N.A., San Francisco, CA (US)

(72) Inventors: Andrea Renee Leighton, San Francisco, CA (US); Alexander Youngblood Windsor, San Francisco, CA (US)

(73) Assignee: Wells Fargo Bank, N.A., San Francisco, CA (US)

(21) Appl. No.: 18/235,316

(22) Filed: Aug. 17, 2023

(51) Int. Cl. G06Q 30/0251; G06F 16/951; G06Q 50/00; H04L 67/306

(52) U.S. Cl. CPC G06Q 30/0252; G06F 16/951; G06Q 30/0255; G06Q 30/0259; G06Q 30/0261; G06Q 30/0269; G06Q 50/01; H04L 67/306

(57) ABSTRACT

A computing system includes at least one processing circuit to receive, via a network interface, an indication to link a user profile of a first third party system with an account of a provider institution; transmit, via the network interface, a request for interaction data of the first third party system; receive, via the network interface, the interaction data associated with the user profile; transmit, via the network interface, a request for third party information of a second third party system; receive, via the network interface, the third party information of the second third party system; compare the received interaction data and the received third party information to determine at least one correlation between the interaction data and the third party information; and transmit, via the network interface, to a user device, a notification based on the at least one correlation.

### TECHNICAL FIELD

The present disclosure relates to systems, computer-readable media, and methods for generating, providing, and managing automatic notifications based on user preferences.

### BACKGROUND

Many individuals prefer to attend events or engage with merchants based on personal preferences. Searching for such events or merchants can conventionally include laborious research through multiple devices, websites, and/or databases. However, these processes can be time consuming, ineffective, and inefficient. Therefore, to increase personalization and reduce latencies, customers may desire computerized systems and methods to provide and manage tailored and custom notifications for various activities to immediately and automatically determine events and merchants based on a user's history or personal preferences.

### SUMMARY

At least one arrangement relates to a computing system of a provider institution, comprising: a network interface configured to communicate with a user device and a plurality of third party systems; a database structured to store a plurality of accounts held by the provider institution; and at least one processing circuit comprising one or more processors and memory structured to store instructions that are executable to cause the at least one processing circuit to: receive, via the network interface and according to a first input to the user device, an indication to link a user profile associated with a user of a first third party system of the plurality of third party systems with an account of the plurality of accounts of the provider institution; transmit, via the network interface, a first request for interaction data of the first third party system, the first request transmitted to a third party application programing interface (API) and including information corresponding to credentials of the user profile; receive, via the network interface from the first third party system responsive to the first request, the interaction data associated with the user profile of the first third party system, the interaction data comprising interactions of the user with the first third party system relating to one or more types of content; transmit, via the network interface, a second request for third party information of a second third party system; receive, via the network interface, the third party information of the second third party system, the third party information comprising data indicative of a transaction history of an entity associated with the second third party system with one or more third parties; compare the received interaction data and the received third party information to determine at least one correlation between the interaction data and the third party information, the at least one correlation determined according to a match between a type of content of the one or more types of content to a keyword associated with a third-party of the one or more third parties; and transmit, via the network interface, to the user device, a notification based on the at least one correlation, the notification identifying the entity.

At least one arrangement relates to a computer-based method, comprising: receiving, by a computing system of a provider institution and via a first input to a user device communicably coupled to the computing system, an indication to link a user profile associated with a user of a first third party system of a plurality of third party systems communicably coupled to the computing system with an account of a plurality of accounts of the provider institution; transmitting, by the computing system and via a third party application programing interface (API), a first request for interaction data of the first third party, the first request including information corresponding to credentials of the user profile; receiving, by the computing system and via the third party API responsive to the first request, the interaction data associated with the user profile of the first third party system, the interaction data comprising interactions of the user with the first third party system relating to one or more types of content; transmitting, by the computing system, a second request for third party information of a second third party system; receiving, by the computing system, the third party information of the second third party system, the third party information comprising data indicative of a transaction history of an entity associated with the second third party system with one or more third parties; comparing, by the computing system, the received interaction data and the received third party information to determine at least one correlation between the interaction data and the third party information, the at least one correlation determined according to a match between a type of content of the one or more types of content to a keyword associated with a third party of the one or more third parties; and transmitting, by the computing system, to the user device, a notification based on the at least one correlation, the notification identifying the entity.

At least one arrangement relates to a non-transitory computer readable medium storing instructions that, when executed by at least one processor, cause the at least one processor to: receive, via a network interface and according to a first input to a user device, an indication to link a user profile associated with a user of a first third party system of a plurality of third party systems with an account of a plurality of accounts of a provider institution; transmit, via the network interface, a first request for interaction data of the first third party system, the first request transmitted to a third party application programing interface (API) and including information corresponding to credentials of the user profile; receive, via the network interface from the first third party system responsive to the first request, the interaction data associated with the user profile of the first third party system, the interaction data comprising interactions of the user with the first third party system relating to one or more types of content; transmit, via the network interface, a second request for third party information of a second third party system; receive, via the network interface, the third party information of the second third party system, the third party information comprising data indicative of a transaction history of an entity associated with the second third party system with one or more third parties; compare the received interaction data and the received third party information to determine at least one correlation between the interaction data and the third party information, the at least one correlation determined according to a match between a type of content of the one or more types of content to a keyword associated with a third-party of the one or more third parties; and transmit, via the network interface, to the user device, a notification based on the at least one correlation, the notification identifying the entity.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

FIG. 1 is a block diagram of a computing environment for generating, providing, and managing automatic notifications based on user history and preferences, according to an example embodiment.

FIG. 2 is flow diagram of a method for generating, providing, and managing automatic notifications based on information regarding a user, such as a location of a user, according to an example embodiment.

FIG. 3 is flow diagram of a method for generating, providing, and managing automatic notifications based on user preferences and history, according to an example embodiment.

FIGS. 4A and 4B are graphical user interfaces presented to a customer during an automatic notification process, according to various embodiments.

FIGS. 5A-5E are graphical user interfaces presented to a customer during an automatic notification process, according to various additional example embodiments.

### DETAILED DESCRIPTION

Referring generally to the Figures, systems, computer-readable media, apparatuses, and methods for automatically generating, providing, and managing notifications based on a user's preferences are disclosed, according to various embodiments herein. The systems, computer-readable media, apparatuses, and methods described herein may automatically receive information, such as a location, regarding a user device associated with a user, determine at least one event happening nearby (within a predefined distance) the user device based on the location, compare the nearby events with a user's profile information (e.g., financial history), and transmit a notification to the user device indicating at least one nearby event that corresponds to a user's preferences based on their profile information. Furthermore, the systems, computer-readable media, apparatuses, and methods described herein may allow various third party entities (e.g., merchants, charities, etc.) to register with a financial institution. The systems, computer-readable media, apparatuses, and methods described herein may allow a user to link a profile/account of a social media network with a financial account of the user at the financial institution so that the financial account may automatically receive interaction/account activity of the user's profile. The systems, computer-readable media, apparatuses, and methods described herein may compare the received interaction activity of the user's profile with information from the registered third party entities and transmit a notification to the user device indicating any third party entities that correspond to at least one preference of a user based on their social media account activity.

As described herein, one potential application of the systems, methods, apparatuses, and computer-readable media may be in a matching or connection environment, such as in connecting or matching users with charitable entities that may be of interest to the users (e.g., to facilitate the user donating to entities of interest, such that the user may be referred to herein as a donor when describing this exemplary application). Additionally or alternatively and in operation, the systems, methods, apparatuses, and computer-readable media described herein may compare a user's financial history with information associated with registered third party entities and may transmit or cause transmission of a notification to a user device associated with the user indicating any third party entities that have a donation history aligning with a user's preferences, which may be based on or determined to be based on their social media account activity and/or their financial history. In some implementations, the systems, methods, apparatuses, and computer-readable media described herein may transmit a notification to the user device when the location of the user device is within a predetermined distance of one or more identified third party entities.

Beneficially, the disclosed systems, methods, and computer implementations may provide notification functionalities that improve current computing systems, such as payment systems, by automatically determining specific merchants (e.g., to encourage transactions at retailers aligned with a user's donation preferences) and events based on a user's preferences via a reduced number of computing sessions or other processes. For example, conventionally, each time a user wishes to find an event or merchant of interest based on personal preferences, the user may use various separate applications (such as a third-party search engines), merchant specific applications, online marketplace applications, and so on. By reducing the number of applications required, the clock time, click path, processing time, programmatic instructions, and other requirements of the central processing unit, memory utilization, and other system resources are reduced. Also, not needing to switch between multiple applications enhances security and efficiency.

The technological solutions discussed herein are not routine or conventional. For example, it is unconventional to selectively transmit notifications to a user device based on behaviors and circumstances of the user. It is also unconventional to provide specific notifications based on factors that are independent of how the user interacts with the application (e.g., based on a user's account history, based on a user's social media activity, etc.). It is moreover unconventional to provide an application that only stores locally the features (e.g., the executable code corresponding with various functionality) that are determined to be relevant to a particular user based on his or her preferences, and that retrieves additional features on an as-needed basis. Various other technical benefits and advantages are described in greater detail below.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

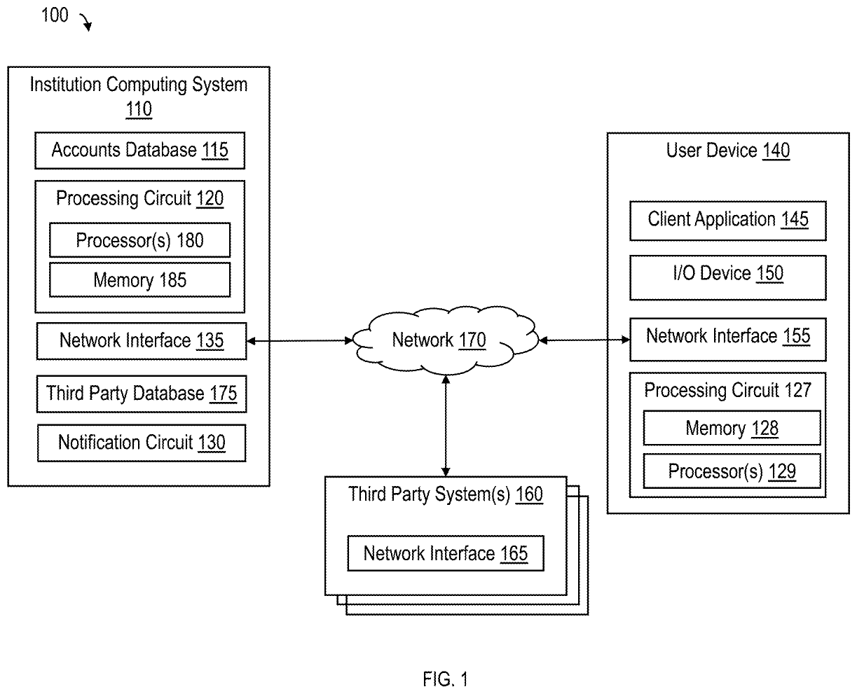

FIG. 1 is a diagram of a computing environment 100 for providing automatic notifications to a user based on a user's preferences, location, and/or history, according to an example embodiment. As shown, the computing environment 100 includes one or more institution computing systems 110 associated with a provider (e.g., a financial institution), one or more user devices 140 associated with one or more users, and/or one or more third party systems 160. The institution computing system(s) 110, the user device(s) 140, and the third party system(s) 160 are in communication with each other and are connected by a network 170, which may include one or more of the Internet, cellular network, Wi-Fi, Wi-Max, a proprietary banking network, or any other type of wired or wireless network or a combination of wired and wireless networks. As described herein, the computing environment 100 may be used to provide a user interface and/or automated notifications to the user device 140 to provide recommendations based on a user's history, location, and/or other preferences.

For clarity, the following description will refer to an institution computing system 110 and a third party system 160. However, it will be understood that the following description of any of these devices and computing systems will be similarly applicable to any additional corresponding devices and computing systems (e.g., additional institution computing systems 110 or third party systems 160) and that, in some embodiments, the computing environment 100 may include a plurality of any of the described devices and systems.

The institution computing system 110 is owned by, associated with, or otherwise operated by a provider institution (e.g., a bank or other financial institution) that maintains one or more accounts held by various customers (e.g., the customer associated with the user device 140), such as demand deposit accounts, credit card accounts, receivables accounts, and so on. In some instances, the institution computing system 110, for example, may include one or more servers, each with one or more processing circuits having one or more processors configured to execute instructions stored in one or more memory devices to send and receive data stored in the one or more memory devices and perform other operations to implement the methods described herein associated with logic or processes shown in the figures. In some instances, the institution computing system 110 may be or may include various other devices communicably coupled thereto, such as, for example, desktop or laptop computers (e.g., tablet computers), smartphones, wearable devices (e.g., smartwatches), and/or other suitable devices.

In some embodiments, the institution computing system 110 includes an accounts database 115, a network interface 135, a third party database 175, a notification circuit 130, and at least one processing circuit 120 having at least one memory 185 and one or more processors 180. In some instances, the network interface 135 includes, for example, program logic that connects the institution computing system 110 to the network 170. The network interface 135 facilitates secure communications between the institution computing system 110 and each of the user device(s) 140 and third party system(s) 160. The network interface 135 also facilitates communication with other entities, such as other banks, settlement systems, and so on. The network interface 135 further includes user interface program logic configured to generate and present web pages to users accessing the institution computing system 110 over the network 170.

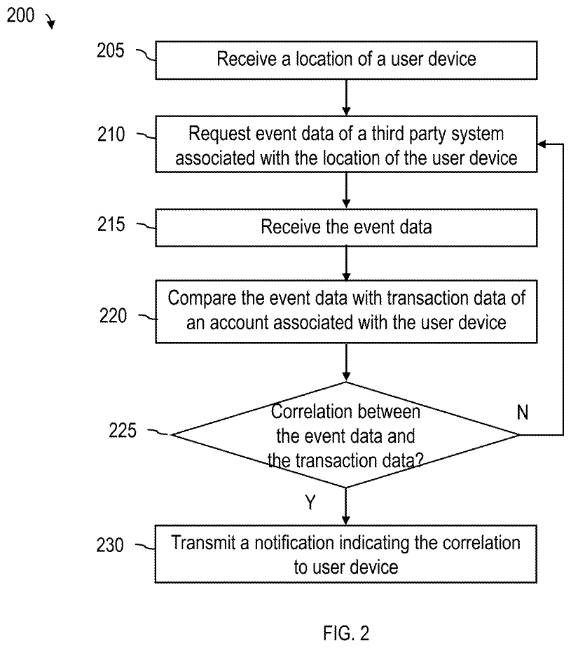

The institution computing system 110 an include at least one a notification circuit 130. The notification circuit 130 is structured or configured to perform a variety of functionalities or operations to enable and monitor various customer activities (e.g., account processing, payment processing, etc.) in connection with customer account information stored within the accounts database 115. For example, the notification circuit 130 may be configured to monitor, retrieve, and/or pull transaction data and/or historical data from one or more customer accounts associated with the user device 140, and/or a variety of other functionalities, as described in greater detail with reference to FIGS. 2-5E.

The accounts database 115 is structured or configured to retrievably store account information associated with various customers having accounts at the financial institution. In some instances, the account information may include a customer name, transaction history, a phone number, an e-mail address, a physical address, a token (e.g., a tag or address associated with a particular account), account information and/or number, etc. of the customer accounts.

In some instances, the account information may include transaction information, information pertaining to a type and corresponding capabilities of the given account, a service token (e.g., a phone number, an e-mail address, or a tag associated with a particular service account) associated with the customer account to enable transactions between various entities, etc. of the customer account. As will be described further herein, the notification circuit 130 may be configured to use data/entries from the account database 115 to identify various correlations between a user's preferences, to provide automatic notifications for a user in a variety of circumstances.

The third party database 175 is structured or configured to retrievably store third party information associated with various third party systems 160. In some instances, the third party information may include a name, a phone number, an e-mail address, a physical address, a website address (e.g., uniform resource location (URL)), a token (e.g., a tag or address associated with a particular account), account information, donation history, a description, a predetermined selected category, etc. of the third party system 160.

The user device 140 is owned, operated, controlled, managed, and/or otherwise associated with a customer (e.g., a customer of the financial institution). In some embodiments, the user device 140 may be or may include, for example, a desktop or laptop computer (e.g., a tablet computer), a smartphone, a wearable device (e.g., a smartwatch), a personal digital assistant, and/or any other suitable computing device. In the example shown, the user device 140 is structured as a mobile computing device, namely a smartphone.

In some embodiments, the user device 140 includes one or more I/O devices 150, a network interface 155, and one or more client applications 145. While the term “I/O” is used, it should be understood that the I/O devices 150 may be input-only devices, output-only devices, and/or a combination of input and output devices. In some instances, the I/O devices 150 include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the customer to provide inputs (such as a touchscreen display, stylus, keyboard, force sensor for sensing pressure on a display screen, etc.). In some instances, the I/O devices 150 further include one or more user interfaces (devices or components that interface with the customer), which may include one or more biometric sensors (such as a fingerprint reader, a heart monitor that detects cardiovascular signals, face scanner, an iris scanner, etc.).

The network interface 155 includes, for example, program logic and various devices (e.g., transceivers, etc.) that connect the user device 140 to the network 170. The network interface 155 facilitates secure communications between the user device 140 and each of the institution computing system 110 and/or the third party system 160. The network interface 155 also facilitates communication with other entities, such as other banks, settlement systems, and so on.

The user device 140 includes at least one processing circuit 127 having at least one memory 128 and at least one processor 129. The user device 140 stores in computer memory 128, and executes (“runs”) using one or more processors 129, various client applications 145, such as an Internet browser presenting websites, text messaging applications (e.g., for sending MMS or SMS to the institution computing system 110 and/or third party system 160), and/or applications provided or authorized by entities implementing or administering any of the computing systems in computing environment 100.

For example, in some instances, the client applications 145 include a customer provider institution client application (e.g., a financial institution banking application) provided by and at least partly supported by the institution computing system 110. For example, in some instances, the client application 145 coupled to the institution computing system 110 may enable the customer to perform various customer activities (e.g., account management, tracking, etc.) and/or perform various transactions (e.g., transferring money to a particular merchant, etc.) associated with one or more customer accounts of the customer held at the provider institution associated with the institution computing system 110 (e.g., account opening and closing operations, fund transfers, etc.). The client application 145 may be referred to as a provider institution client application herein. In some arrangements, the client applications 145 are hard coded onto the memory of the user device 140. In another embodiment, these applications are web-based interface applications, where the user has to log onto or access the web-based interface before usage, and these applications are supported by a separate computing system comprising one or more servers, processors, network interface circuits, or the like (e.g., the institution computing system 110), that transmit the applications for use to the mobile device. In some arrangements, the client application 145 may be an application downloaded by a user via an app store or mobile wallet provider.

In some instances, the client application 145 provided by the institution computing system 110 may additionally be coupled to the third party system(s) 160 (e.g., via one or more application programming interfaces (APIs) and/or software development kits (SDKs)) to integrate one or more features or services provided by the third party system(s) 160. In some instances, the third party system(s) 160 may alternatively and/or additionally provide services via a separate client application 145.

The third party system 160 includes a respective network interface 165 to facilitate exchanging data with the institution computing system 110 and/or the user device 140 through the network 170. The third party system 160 may be associated with a third party entity. For example, the third party entity may be or may include various merchants and/or social media networks/websites (e.g., Facebook, Ticketmaster, etc.). The third party system 160 may include one or more APIs and/or servers associated with the third party entity for exchanging data with the institution computing system 110 and/or the user device 140, as described herein.

With an example structure of the computing environment 100 being described above, example processes performable by the computing environment 100 (or components/systems thereof) will be described below. It should be appreciated that the following processes are provided as examples and are in no way meant to be limiting. Additionally, various method steps discussed herein may be performed in a different order or, in some instances, completely omitted. These variations have been contemplated and are within the scope of the present disclosure.

Referring now to FIG. 2, a flow diagram of a method 200 of automatically providing notifications to a user based on a user's location is shown, according to an example embodiment. Various operations of the method 200 may be conducted by components/elements of the computing environment 100 and/or parts thereof (e.g., the institution computing system 110, the user device 140, and/or the third party system 160).

As a brief overview, at process 205, the institution computing system 110 (e.g., the notification circuit 130) receives a location of a user device 140. At process 210, the notification circuit 130 requests even data of a third party system 160 associated with the location of the user device 140. At process 215, the notification circuit 130 receives the event data. At process 220, the notification circuit 130 compares the event data with transaction data of an account. At process 225, the notification circuit 130 determines if there is a correlation between the event data and the transaction data. If the notification circuit 130 determines there is a correlation, the notification circuit 130 proceeds to process 230 and transmits a notification to the user device 140. If the notification circuit 130 determines there is no correlation, the notification circuit 130 returns to process 210.

In greater detail, at process 205, the notification circuit 130 may be configured to receive a location of a user device 140. The notification circuit 130 may be configured to receive a location of a user device 140 responsive to a user opting into a location service via the client application 145. For example, the notification circuit 130 may be configured to provide a prompt to the user device via the client application 145 (e.g., a pop-up window, a push notification, a splash page, etc.) asking if the user wishes to opt into a location service. Responsive to receiving an input indicating a selection to opt into the location service, the notification circuit 130 may be configured to transmit a request for a location of the user device 140.

The notification circuit 130 may be configured to receive the location via various sensors (e.g., the Global Positioning System (GPS)) of the user device 140 via the network 170. In some implementations, the notification circuit 130 may be configured to receive various components to facilitate identifying the location of the user device 140. For example, the notification circuit 130 may be configured to receive a geolocation of the user device 140 and/or one or more GPS coordinates of the user device 140. The notification circuit 130 may be configured to triangulate an exact location of and/or determine a geofence defining an area surrounding the user device 140 using the plurality of GPS coordinates of the user device 140 and/or the geolocation.

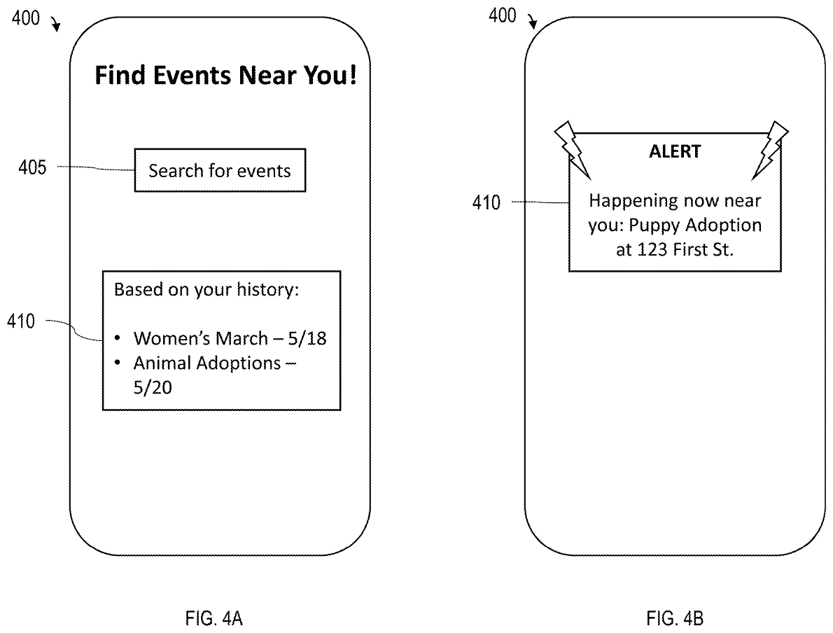

In some implementations, the notification circuit 130 may be configured to receive the location of the user device 140 periodically over time (e.g., every 10 minutes, every hour, once a day, etc.). In some implementations, the notification circuit 130 may be configured to receive the location of the user device 140 responsive to receiving an input to a user interface of the user device 140. For example, the notification circuit 130 may be configured to generate and provide (e.g., via the network 170) a user interface 400 to the user device 140, as depicted in FIG. 4A. The notification circuit 130 may be configured to provide the user interface 400 responsive to the client application 145 launching on the user device 140, responsive to receiving log-in credentials to the client application 145 on the user device 140, and/or responsive to receiving registration information for a user account of the client application 145. As depicted in FIG. 4A, the user interface 400 may include at least one selectable search request feature 405. For example, a manual user input to the search request feature 405 may indicate that a user wishes to search for various nearby or local events for a user to attend. Responsive to receiving an input to the search request feature 405, the notification circuit 130 may be configured to request and/or determine a location of the user device 140 (e.g., by receiving a geolocation, GPS coordinates, etc.).

At process 210, the notification circuit 130 may be configured to request event data of a third party system 160 based on the received location of the user device 140. For example, in some implementations, the notification circuit 130 may be configured to input the determined location of the user device 140 into a plurality of public third party databases that store event data. In some implementations, the notification circuit 130 may be configured to establish a communication link with one or more third party systems 160. For example, a server of the institution computing system 110 may be configured to transmit one or more API calls to a third party system 160 to request various event data. The institution computing system 110 may be configured to request, for example, one or more events happening within a predetermined distance of the location of the user device 140 and/or within a predetermined period of time. The request may include various other parameters defining the requested event data. For example, a one or more parameters can be defined by user inputs to the client application 145 (e.g., by a user manually selecting a location, a time, a date, a category of events, etc.). In other words, the institution computing system 110 (e.g., via the client application 145) may be configured to allow dynamic filtering of requested event data. Such dynamic filtering may facilitate significantly reducing processing power and/or the amount of time it takes for the institution computing system 110 to complete the request. The one or more third party systems 160 may include, for example, a social media network and/or a merchant or retailer. For example, the third party system 160 may be or may include one or more ecommerce sites or social, event, or venue-based networks or merchants such as Eventbrite, Ticketmaster, Facebook, etc. In some implementations, one or more third party systems 160 may be associated with a charity or non-profit organization.

At process 215, the notification circuit 130 may be configured to receive the requested event data. For example, the server of the institution computing system 110 may be configured to receive the event data responsive to transmitting the at least one API call. The event data may include various information of one or more events (e.g., concerts, marches, gatherings, markets, fairs, etc.). For example, the “event data” or information may include, but is not limited to, a date, time, location, price, associated organization, and/or other details of the event happening at or within a predetermined distance of the determined location of the user device 140 (e.g., within 25 miles, within 50 miles, etc.). By way of illustrative example, the notification circuit 130 may be configured to receive a geolocation of the user device 140 and may be configured to input the geolocation into a predetermined database including a collection of known upcoming events of a plurality of locations. The notification circuit 130 may be configured to receive, as an output from the database, at least one event and information of the event at a location within a predetermined distance of the geolocation of the user device 140. As another illustrative example, the notification circuit 130 may be configured to cause the institution computing system 110 to transmit one or more API calls requesting event data within a predetermined distance of the location to at least one third party system 160 (e.g., Ticketmaster). The notification circuit 130 may be configured to receive, responsive to the API call via the established API link, the requested event data from the third party system 160.

At process 220, the notification circuit 130 may be configured to compare the received event data with historical transaction data of an account associated with the user device 140 and stored in the accounts database 115. For example, the notification circuit 130 may be structured to extract various information associated with a user's transaction history (e.g., spending habits including names of merchants, amount spent, items purchased, etc.) stored in the accounts database 115. The notification circuit 130 may be configured to compare the event data with the transaction history by comparing keywords between the data sets. By way of illustrative example, the notification circuit 130 may be configured determine a user has made multiple transactions at a pet store within a predetermined period of time (e.g., a month, a year, etc.). Responsive to determining the user had made multiple transactions at a pet store, the notification circuit 130 may be configured to parse the received event data for keywords associated with “pet store.”

At process 225, the notification circuit 130 may be configured to determine if a correlation exists between the received event data and the historical transaction data. For example, the notification circuit 130 may be configured to extract one or more events having matching keywords associated with one or more transactions. Continuing with the above-described illustrative example, the notification circuit 130 may be configured to extract, based on the parsed information, an event for raising funds for animals or pets in need. In some implementations, the notification circuit 130 may be configured to use one or more machine learning models stored in the institution computing system 110 to determine if a correlation exists between the received event data and the historical transaction data. For example, the machine learning models may be trained using historical data stored within the accounts database 115. The various machine learning models may include neural networks (e.g., convolutional neural networks, deep neural networks), Support Vector Machines (SVMs), Random Forests, or the like. The machine learning models may be trained on known input-output pairs given known inputs. For example, the machine learning models may be trained to predict associations with known key word inputs. By way of example, the machine learning models may be configured to determine the key word “pet” is also associated with “animal,” “puppy,” “kitten,” “adoption,” “shelter,” etc. to further refine the notification circuit 130 determining whether a correlation exists, even when terms do not exactly match.

If the notification circuit 130 determines a correlation does not exist, the notification circuit 130 may return to process 210. If the notification circuit 130 determines a correlation exists between the received event data and the historical transaction data, the notification circuit 130 may be configured to transmit a notification to the user device 140 based on the correlation at process 230. For example, as depicted in FIG. 4A, the notification circuit 130 may be configured to render the notification 410 as a window, pop-up, or section on the user interface 400. For example, the notification circuit 130 may be configured to transmit the notification 410 as a window, pop-up, or section on the user interface 400 when the respective event is within a predetermined time period of the current time of the user device 140 (e.g., within one day to one month, etc.) and/or within a predetermined distance of the location of the user device 140 (e.g., within 1 mile to 50 miles, etc.).

FIG. 4B depicts another example user interface 400 generated by the notification circuit 130 and provided the user device 140. As depicted in FIG. 4B, the notification 410 may be a push notification rendered on the user device 140. For example, in some implementations, the notification circuit 130 may be configured to transmit the notification 410 as a push notification based on a time or date of the respective event. For example, the notification circuit 130 may be configured to transmit the notification 410 as a push notification when the respective event is within a predetermined time period of the current time of the user device 140 (e.g., within 24 hours, etc.) and/or within a predetermined distance of the location of the user device 140 (e.g., within 1 mile, etc.). The notification circuit 130 may be configured to cause haptic feedback (e.g., sounds, vibrations, etc.) to render on the user device 140 with transmitting the notification 540.

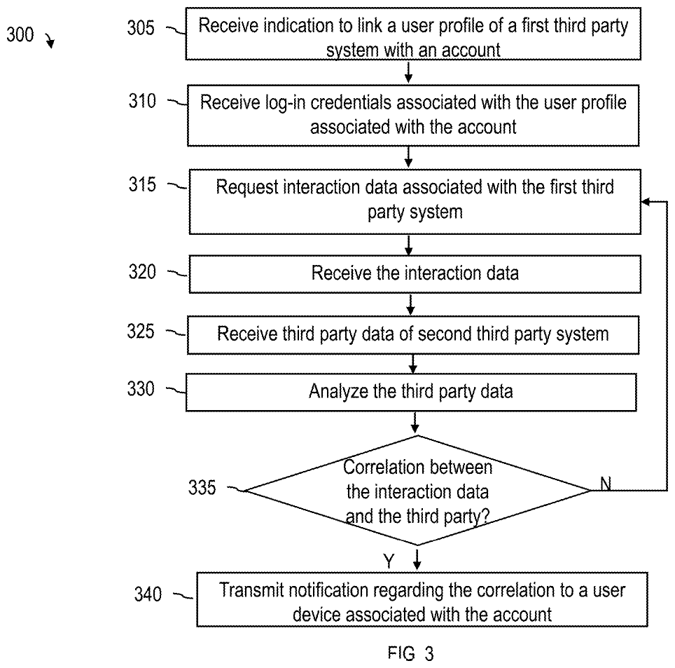

Referring now to FIG. 3, a flow diagram of a method 300 of automatically providing notifications to a user based on a user's interactions with third party systems 160 is shown, according to an example embodiment. Various operations of the method 300 may be conducted by the computing environment 100 and particularly parts thereof (e.g., the institution computing system 110, the user device 140, and/or the third party system 160).

As a brief overview, at process 305, the institution computing system 110 (e.g., the notification circuit 130) receives an indication to link a user profile of a first third party system 160 with an account. At process 310, the notification circuit 130 receives log-in credentials of a user profile. At process 315, the notification circuit 130 requests interaction data of the first third party system 160. At process 320, the notification circuit 130 receives the interaction data. At process 325, the notification circuit 130 receives third party information of a second third party system 160. At process 330, the notification circuit 130 analyzes the third party information and the interaction data. At process 335, the notification circuit 130 determines if there is a correlation between the third party information and the interaction data. If the notification circuit 130 determines there is no correlation, the notification circuit 130 may return to process 315. If the notification circuit 130 determines there is a correlation, the notification circuit 130 may proceed to process 340 and transmit a notification based on the correlation to the user device 140.

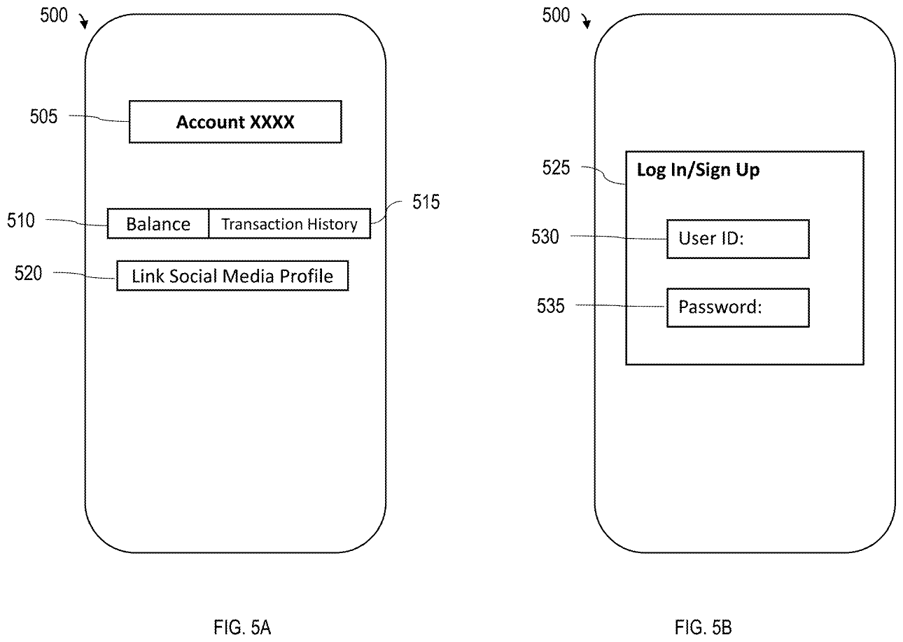

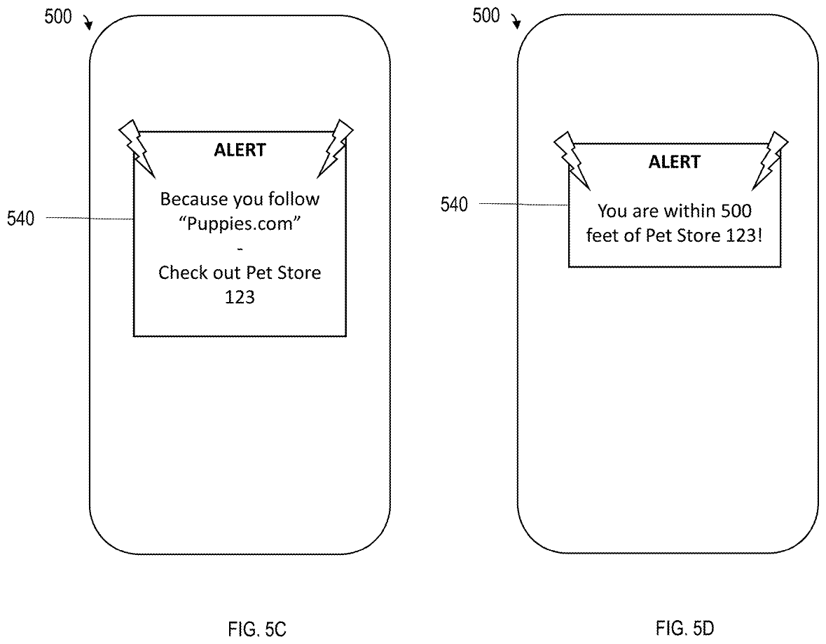

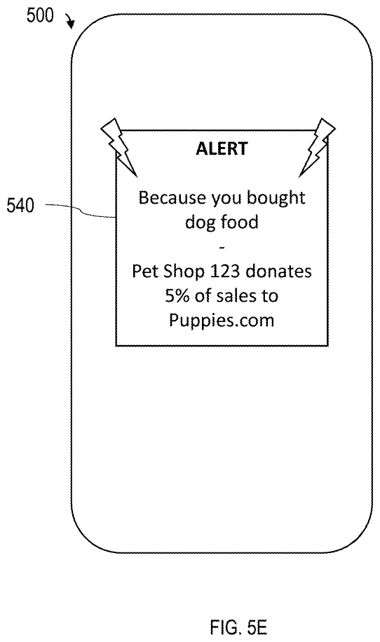

In greater detail, at process 305, the notification circuit 130 may be configured to receive an indication to link a user profile of a first third party system 160 with an account associated with a user device 140 stored in the accounts database 115. For example, the notification circuit 130 may be configured to receive the indication to link the user profile of the first third party system 160 with the account of the user device 140 responsive to receiving an input to a user interface of the user device 140. For example, the notification circuit 130 may be configured to generate and provide (e.g., via the network 170) a user interface 500 to the user device 140, as depicted in FIG. 5A. The notification circuit 130 may be configured to provide the user interface 500 responsive to the client application 145 launching on the user device 140, responsive to receiving log-in credentials to the client application 145 on the user device 140, and/or responsive to receiving registration information for a user account of the client application 145. As depicted in FIG. 5A, the user interface 500 may include an account number 505 and/or name of at least one account associated with a user of the user device 140. For example, the account may be associated with the client application 145 (e.g., a mobile banking account associated with a name of a user and/or log-in credentials for the client application 145 stored in the accounts database 115). The user interface 500 may include at least one selectable feature. For example, the user interface 500 may include, but is not limited to, a balance selectable feature 510, a transaction history selectable feature 515, and/or a link user profile selectable feature 520.

Responsive to receiving an input to the balance selectable feature 510, the notification circuit 130 may be configured to render a current balance of the account. Responsive to receiving an input to the transaction history selectable feature 515, the notification circuit 130 may be configured to render a list of recent transactions of the account (e.g., stored in the accounts database 115). Responsive to receiving an input to the link user profile selectable feature 520, the notification circuit 130 may be configured to receive the indication to link a user profile of a first third party system 160 with the account. For example, the first third party system 160 may include one or more social media networks (e.g., Facebook, YouTube, Instagram, TikTok, etc.) and the user profile may include an account or profile of a user registered with the social media network.

At process 310, the notification circuit 130 may be configured to receive log-in credentials of the user profile associated with the first third party system 160. For example, responsive to receiving a manual user input to the link user profile selectable feature 520 on the user interface 500, the notification circuit 130 may be configured to render a pop-up window 525 on the user interface 500, as depicted in FIG. 5B. For example, in some implementations, the institution computing system 110 (e.g., via an application programming interface (API)) may be configured to cause an application or website associated with the social media network to launch within the client application 145 on the user device 140 (e.g., to launch the window 525 within the client application 145). The notification circuit 130 may be configured to render a user's account of the social media network responsive to receiving one or more log-in credentials associated with the account (e.g., biometric data, a username 530, password 535, etc.). In some implementations, a social media application associated with the third party system 160 may include an API that enables communication between the social media application and the client application 145. For example, the notification circuit 130 may be configured to launch a social media application on the user device 140.

At process 315, the notification circuit 130 may be configured to transmit a request for interaction data of the first third party system 160 (e.g., of the social media network). For example, in some implementations, the notification circuit 130 may be configured to automatically pull usage data and other metrics from the rendered social media application on the user device 140 via the API (e.g., by including information corresponding to credentials, such as log-in credentials described herein, of the user profile). In some implementations, the notification circuit 130 may be configured to cause a server of the institution computing system 110 to transmit an API call to the social media network to request interaction data (e.g., by including information corresponding to credentials, such as log-in credentials described herein, of the user profile). The “interaction data” may include, but is not limited to, interactions of a user associated with the user profile with the social media network relating to one or more types of content (e.g., various use metrics of the user profile of the social including, but not limited to, a user's “likes,” comments, shares, followers or following, and/or other activity data stored and associated with the user profile of the social media network).

At process 320, the notification circuit 130 may be configured to receive the requested interaction data. For example, in some implementations, the notification circuit 130 may be configured to receive the requested interaction data responsive to transmitting an API call to the third party system 160. In some implementations, the notification circuit 130 may be configured to receive a user input to the window 525 displayed on the user device 140 to receive a selection of one or more images, videos, pages, or other graphics (e.g., responsive to a user selecting the one or more photos and media displayed in the window) to receive the interaction data. Responsive to a user selecting one or more photos, pages, videos, and/or other media, the social media application may be configured to provide the selected data to the institution computing system 110 (e.g., via the API).

At process 325, the notification circuit 130 may be configured to receive third party information of at least one second third party system 160. In some implementations, the notification circuit 130 may be configured to receive the third party information responsive to a request. For example, in some implementations, the notification circuit 130 may be configured to receive one or more data packets (e.g., digitalized versions of one or more documents, etc.) including information of a third party system 160 during a registration process for various third party systems 160 to be stored in the third party database 175. For example, the notification circuit 130 may be configured to receive the information responsive to transmitting a request for information to one or more third party systems 160 for registering the third party systems 160 with a service of the institution computing system 110. The request may include, for example, a predefined file format for a user of the third party system 160 to complete and transmit back to the institution computing system 110. The notification circuit 130 may be configured to extract the information from the predefined file format. By way of example, the notification circuit 130 may be configured to transmit a message (e.g., email, SMS, notification, etc.) to the third party systems 160. The message may include one or more manual inputs for a user to complete to provide information (e.g., a selection of a category type of the establishment associated with the third party system 160, a name, an address, tokens and/or identifiers, a URL, an employer identification number (EIN), donation history of the third party system 160, a description, image, or other media of the third party system 160, and/or other various information).

The notification circuit 130 may be configured to receive the information responsive to the third party system 160 transmitting the completed message back to the institution computing system 110 to complete the registration. In some implementations, the information of the third party system 160 may include a selection of a finite number of category types (e.g., animals, arts, children, education, emergency relief, environment, health, international, poverty, public benefit, military, religion, social services, other, etc.). The notification circuit 130 may be configured to store the received third party system 160 information in the third party database 175. In some implementations, the notification circuit 130 may be configured to receive a plurality of third party information of a plurality of third party systems 160 to store the third party information within the third party database 175 and to register each of the third party system 160 with a service of the institution computing system 110. For example, at least one third party system 160 (e.g., sometimes referred to the “second third party system” herein) may be, for example, an entity including one or more various merchants registering for a promotional service of the institution computing system 110 (e.g., the institution computing system 110 may be configured to recommend a third party entity associated with the third party system 160 based on a user's preferences, as described herein). In some implementations, the third party system 160 may be associated with a third party, such as a charity or non-profit organization. The third party information may include data indicative of a transaction history of the entity associated with the third party system 160 (e.g., a merchant or retailer) with one or more third parties (e.g., a charity or non-profit organization). For example, during the registration process, the third party systems 160 may be configured to provide documentation including a history of donations made to various charities (e.g., via one or more tax forms of a predefined format).

At process 330, the notification circuit 130 may be configured to analyze the interaction data of the user profile of the first third party system 160 and the received third party information of the at least one third party system 160 registered and stored in the third party database 175. In some implementations, the notification circuit 130 may be configured to compare the received interaction data with the received third party system data of the third party systems 160 stored in third party database 175. For example, responsive to receiving the requested interaction data of the user profile of the first third party system 160 (e.g., the social media network), the notification circuit 130 may be configured to parse the third party database 175 of the plurality of registered third party systems 160 for keywords or phrases associated with the interaction data.

At process 335, the notification circuit 130 may be configured to determine if a correlation exists between the received interaction data and the third party system information stored in the database. For example, the notification circuit 130 may be configured to extract third party information of the third party systems 160 having matching keywords associated with the interaction data. The notification circuit 130 may be configured to determine a correlation exists based on a match between a type of content (e.g., social media activity) to a keyword associated with a third party. By way of illustrative example, the interaction data may indicate that a user of the user profile follows, “likes,” or otherwise interacts with an organization associated with animals. The notification circuit 130 may be configured to parse the information of the plurality of third party systems 160 for an indication of a third party system 160 associated with animals (e.g., based on the plurality of predetermined categories, information provided by the third party systems 160, etc.). In some implementations, the notification circuit 130 may be configured to use one or more machine learning models stored in the institution computing system 110 to determine if a correlation exists between the received interaction data and the information of the third party systems 160. For example, the machine learning models may be trained using historical data stored within the institution computing system 110. The various machine learning models may include neural networks (e.g., convolutional neural networks, deep neural networks), Support Vector Machines (SVMs), Random Forests, or the like. The machine learning models may be trained on known input-output pairs given known inputs. For example, the machine learning models may be trained to predict associations with known key word inputs. By way of example, the machine learning models may be configured to determine the key word “pet” is also associated with “animal,” “puppy,” “kitten,” “adoption,” “shelter,” etc. to further refine the notification circuit 130 determining whether a correlation exists, even when terms do not exactly match.

If the notification circuit 130 determines a correlation does not exist, the notification circuit 130 may return to process 315. If the notification circuit 130 determines a correlation exists between the received interaction data and the information of the third party systems 160, the notification circuit 130 may be configured to transmit a notification to the user device 140 based on the correlation at process 340. For example, as depicted in FIG. 5C, the notification circuit 130 may be configured to render the notification 540 as a window, pop-up, push notification, or section on the user interface 400. The notification circuit 130 may be configured to cause haptic feedback (e.g., sounds, vibrations, etc.) to render on the user device 140 with transmitting the notification 540.

In some implementations, the notification circuit 130 may be configured to request a location of the user device 140 automatically and/or responsive to determining a correlation exists. Requesting a location of the user device 140 only responsive to determining a correlation exits saves computing resources by only pining the user device 140 once a correlation is determined, as opposed to continuously or cyclically pinging the user device 140 even when no correlation is determined. For example, as described herein, the notification circuit 130 may be configured to request and receive a geolocation of the user device 140 and/or one or more GPS coordinates of the user device 140. The notification circuit 130 may be configured to triangulate an exact location of and/or a determine a geofence defining an area surrounding the user device 140 using the plurality of GPS coordinates of the user device 140 and/or the geolocation. The notification circuit 130 may be configured to compare the third party information of the one or more third party systems 160 having a correlation with the interaction data with the location. For example, the notification circuit 130 may be configured to extract address information (e.g., an address) of the one or more third party systems 160 and compare the address information with the location of the user device 140.

The notification circuit 130 may be configured to determine if the user device 140 is within a threshold distance of the address of the one or more third party systems 160 based on the comparison. For example, the threshold distance can be a predetermined threshold (e.g., a mile, 2 miles, 5 miles, etc.). If the notification circuit 130 determines the one or more addresses are within the threshold distance, the notification circuit 130 may be configured to transmit a notification 540 to the user device 140 indicating that the user device 140 is within the threshold distance, indicating the address of the third party system 160, and/or indicating the user device 140 is close to the third party system 160 in various other ways, as depicted in FIG. 5D. In some implementations, the notification circuit 130 may be configured to transmit the notification 540 as a secondary notification 540 (e.g., separate from a first notification 540 indicating a correlation between the user's interaction data and transaction data), or the notification circuit 130 may be configured to transmit each of the correlation and the indication of the location of the third party system 160 in one single notification 540. In some implementations, the notification circuit 130 may be configured to cause haptic feedback (e.g., sounds, vibrations, etc.) to render on the user device 140 with transmitting the notification 540.

As described herein, the received third party information of the one or more third party systems 160 may include donation history of each respective third party system 160 (e.g., transaction history of an entity associated with the third party system 160 to one or more third party charities). For example, in some implementations, the notification circuit 130 may be configured to receive a donation history of a third party system 160 directly from the third party system 160 (e.g., as a text, image, or predefined file format received during a registration process of the third party system 160 as described herein). For example, during the registration process, the notification circuit 130 may be configured to receive a file containing a list of funds transfers between an account of the third party system 160 and an account of a charity or other non-profit organizations over a predetermined period of time (e.g., 6 months, 1 year, 2 years, etc.). In some implementations, for example, the file may be associated with a tax return statement. The notification circuit 130 may be trained to extract content (e.g., names of charities, amount donated, date donated, etc.) based on the predetermined file format via one or more training tags.

In some implementations, the notification circuit 130 may be configured to determine a donation history in various other ways. For example, the notification circuit 130 may be configured to receive a URL of a website associated with a third party system 160. The notification circuit 130 may be configured to use one or more we scraping algorithms stored in the institution computing system 110 to scrape the website of the third party system 160 for any indication of donation or other charity contributions of the third party systems 160. For example, the third party systems (e.g., various merchants) may indicate publicly on a website a contribution of resources, a partnership, and/or other information associated with charities or nonprofits on the website. The notification circuit 130 may be configured to use one or more web scraping algorithms to scrape and extract such information to determine a donation history of the one or more third party systems 160. By way of illustrative example, a merchant may advertise on its website that it donates 5% of sales to a charity. The notification circuit 130 may be configured to extract this information using one or more scraping algorithms.

Responsive to receiving donation history of the one or more third party systems 160, the notification circuit 130 may be configured to compare the received interaction data of the social media network and/or the pulled transaction history of the user account associated with the user device 140 with the donation history of the one or more third party systems 160. The notification circuit 130 may be configured to determine if one or more correlations exist between the interaction data, the transaction history, and/or the donation history. For example, the notification circuit 130 may be configured to compare the interaction data, the transaction history, and the donation history by comparing keywords between the data sets. By way of illustrative example, the notification circuit 130 may be configured determine a user has purchased pet food at least one time within a predetermined period of time. Responsive to determining the user had purchased pet food, the notification circuit 130 may be configured to parse the donation history for keywords associated with “pet.” As another example, the notification circuit 130 may be configured determine a user has “liked” at least one photo associated with a pet store. Responsive to determining the user had “liked” the photo, the notification circuit 130 may be configured to parse the donation history for keywords associated with “pet store.”

In some implementations, the notification circuit 130 may be configured to use one or more machine learning models stored in the institution computing system 110 to determine if a correlation exists between the received interaction data, the historical transaction data, and/or the donation history of the one or more third party systems 160. For example, the machine learning models may be trained using historical data stored within the accounts database 115. The various machine learning models may include neural networks (e.g., convolutional neural networks, deep neural networks), Support Vector Machines (SVMs), Random Forests, or the like. The machine learning models may be trained on known input-output pairs given known inputs. For example, the machine learning models may be trained to predict associations with known key word inputs. By way of example, the machine learning models may be configured to determine the key word “pet” is also associated with “animal,” “puppy,” “kitten,” “adoption,” “shelter,” etc. to further refine the notification circuit 130 determining whether a correlation exists, even when terms do not exactly match.

Responsive to determining a correlation exists, the notification circuit 130 may be configured to transmit a notification 540 to the user device 140 based on the correlation and/or identifying any determined entities, as depicted in FIG. 5E. In some implementations, the notification circuit 130 may be configured to transmit the notification 540 as a secondary or additional notification 540 (e.g., separate from a first notification 540 indicating a correlation between the user's interaction data and transaction data), or the notification circuit 130 may be configured to transmit each of the correlation and the indication of the location of the third party system 160 in one single notification 540. In some implementations, the notification circuit 130 may be configured to cause haptic feedback (e.g., sounds, vibrations, etc.) to render on the user device 140 with transmitting the notification 540.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112 (f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A computing system associated with a provider institution, the computing system comprising:
a network interface configured to communicate with a user device and a plurality of third party systems;
a database structured to store a plurality of accounts held by the provider institution;
at least one processing circuit comprising one or more processors and memory structured to store instructions that are executable to cause the at least one processing circuit to:
receive, via the network interface and according to a first input to the user device, an indication to link a user profile associated with a user of a first third party system of the plurality of third party systems with an account of the plurality of accounts of the provider institution;
transmit, via the network interface, a first request for interaction data of the first third party system, the first request transmitted to a third party application programing interface (API) and including information corresponding to credentials of the user profile;
receive, via the network interface from the first third party system responsive to the first request, the interaction data associated with the user profile of the first third party system, the interaction data comprising interactions of the user with the first third party system relating to one or more types of content;
transmit, via the network interface, a second request for third party information of a second third party system;
receive, via the network interface, the third party information of the second third party system, the third party information comprising data indicative of a transaction history of an entity associated with the second third party system with one or more third parties;
compare the received interaction data and the received third party information to determine at least one correlation between the interaction data and the third party information, the at least one correlation determined according to a match between a type of content of the one or more types of content to a keyword associated with a third-party of the one or more third parties; and
transmit, via the network interface, to the user device, a notification based on the at least one correlation, the notification identifying the entity.

2. The computing system of claim 1, wherein the third party information comprises an address associated with the entity of the second third party system and the stored instructions further cause the one or more processors to:
receive, via the network interface, a geolocation of the user device;
compare the address with the geolocation of the user device;
determine, based on the comparison, the user device is within a threshold distance of the address; and
transmit, via the network interface, a second notification to the user device indicating the user device is near the address associated with the entity.

3. The computing system of claim 1, wherein the first third party system comprises a social media network and the second third party system comprises a merchant.

4. The computing system of claim 1, wherein the transaction history comprises a donation history of the entity to the one or more third parties.

5. The computing system of claim 1, wherein the third party information of the second third party system comprises a uniform resource locator (URL) of a website associated with the second third party system and wherein the stored instructions further cause the one or more processors to:
extract, using at least one web scraping algorithm, donation history of the entity associated with the second third party system from the website.

6. The computing system of claim 1, wherein the stored instructions further cause the one or more processors to determine, using at least one machine learning algorithm, the at least one correlation between the interaction data and the third party information.

7. The computing system of claim 1, wherein the interactions of the user with the first third party system relating to the one or more types of content comprises various social media account activity.

8. A computer-based method, comprising:
receiving, by a computing system of a provider institution and via a first input to a user device communicably coupled to the computing system, an indication to link a user profile associated with a user of a first third party system of a plurality of third party systems communicably coupled to the computing system with an account of a plurality of accounts of the provider institution;
transmitting, by the computing system and via a third party application programing interface (API), a first request for interaction data of the first third party, the first request including information corresponding to credentials of the user profile;
receiving, by the computing system and via the third party API responsive to the first request, the interaction data associated with the user profile of the first third party system, the interaction data comprising interactions of the user with the first third party system relating to one or more types of content;
transmitting, by the computing system, a second request for third party information of a second third party system;
receiving, by the computing system, the third party information of the second third party system, the third party information comprising data indicative of a transaction history of an entity associated with the second third party system with one or more third parties;
comparing, by the computing system, the received interaction data and the received third party information to determine at least one correlation between the interaction data and the third party information, the at least one correlation determined according to a match between a type of content of the one or more types of content to a keyword associated with a third party of the one or more third parties; and
transmitting, by the computing system, to the user device, a notification based on the at least one correlation, the notification identifying the entity.

9. The method of claim 8, wherein the third party information comprises an address associated with the entity of the second third party system and the method further comprises:
receiving, by the computing system, a geolocation of the user device;
comparing, by the computing system, the address with the geolocation of the user device;
determining, by the computing system, based on the comparison, the user device is within a threshold distance of the address; and
transmitting, by the computing system, a second notification to the user device indicating the user device is near the address associated with the entity.

10. The method of claim 8, wherein the first third party system comprises a social media network and the second third party system comprises a merchant.

11. The method of claim 8, wherein the transaction history comprises a donation history of the entity to the one or more third parties.

12. The method of claim 8, wherein the third party information of the second third party system comprises a uniform resource locator (URL) of a website associated with the second third party system and wherein the method further comprises:
extracting, by the computing system, using at least one web scraping algorithm, donation history of the entity associated with the second third party system from the website.

13. The method of claim 8, further comprising determining, using at least one machine learning algorithm, the at least one correlation between the interaction data and the third party information.

14. The method of claim 8, wherein the interactions of the user with the first third party system relating to the one or more types of content comprises various social media account activity.

15. A non-transitory computer readable medium storing instructions that, when executed by at least one processor, cause the at least one processor to:
receive, via a network interface and according to a first input to a user device, an indication to link a user profile associated with a user of a first third party system of a plurality of third party systems with an account of a plurality of accounts of a provider institution;
transmit, via the network interface, a first request for interaction data of the first third party system, the first request transmitted to a third party application programing interface (API) and including information corresponding to credentials of the user profile;
receive, via the network interface from the first third party system responsive to the first request, the interaction data associated with the user profile of the first third party system, the interaction data comprising interactions of the user with the first third party system relating to one or more types of content;
transmit, via the network interface, a second request for third party information of a second third party system;
receive, via the network interface, the third party information of the second third party system, the third party information comprising data indicative of a transaction history of an entity associated with the second third party system with one or more third parties;
compare the received interaction data and the received third party information to determine at least one correlation between the interaction data and the third party information, the at least one correlation determined according to a match between a type of content of the one or more types of content to a keyword associated with a third-party of the one or more third parties; and
transmit, via the network interface, to the user device, a notification based on the at least one correlation, the notification identifying the entity.

16. The non-transitory computer readable medium of claim 15, wherein the third party information comprises an address associated with the entity of the second third party system and the stored instructions further cause the at least one processor to:
receive, via the network interface, a geolocation of the user device;
compare the address with the geolocation of the user device;
determine, based on the comparison, the user device is within a threshold distance of the address; and
transmit, via the network interface, a second notification to the user device indicating the user device is near the address associated with the entity.

17. The non-transitory computer readable medium of claim 15, wherein the first third party system comprises a social media network and the second third party system comprises a merchant.

18. The non-transitory computer readable medium of claim 15, wherein the transaction history comprises a donation history of the entity to the one or more third parties.

19. The non-transitory computer readable medium of claim 15, wherein the third party information of the second third party system comprises a uniform resource locator (URL) of a website associated with the second third party system and wherein the stored instructions further cause the at least one processor to:
extract, using at least one web scraping algorithm, donation history of the entity associated with the second third party system from the website.

20. The non-transitory computer readable medium of claim 15, wherein the stored instructions further cause the at least one processor to determine, using at least one machine learning algorithm, the at least one correlation between the interaction data and the third party information.
